(19) United States
(12) Patent Application Publication
(10) Pub. No.: US 2025/0376405 A1
(43) Pub. Date: Dec. 11, 2025

(54) METHOD FOR FABRICATING A HOLLOW-CORE FIBER AND FOR FABRICATING A PREFORM FOR A HOLLOW-CORE FIBER, AND PREFORM PRECURSOR THEREFOR

(71) Applicant: Heraeus Quarzglas GmbH & Co. KG, Hanau (DE)

(72) Inventors: Manuel ROSENBERGER, Kleinostheim (DE); Jaqueline PLASS, Kleinostheim (DE); Kay SCHUSTER, Bitterfeld-Wolfen (DE); Burak KOC, Bitterfeld-Wolfen (DE); Yusuf TANSEL, Bitterfeld-Wolfen (DE)

(21) Appl. No.: 19/225,473

(22) Filed: Jun. 2, 2025

(30) Foreign Application Priority Data
Jun. 6, 2024 (EP) 24180449.1

(51) Int. Cl. C03B 37/012

(52) U.S. Cl. CPC C03B 37/01208; C03B 37/01211; C03B 37/01254; C03B 2203/16

(57) ABSTRACT

In a known method for fabricating a preform for an antiresonant hollow-core fiber with an ALIF design, tubular antiresonance element preforms (ARE preforms for short), that each comprise a primary tube and at least two secondary tubes, are evenly distributed around the inside of a cladding tube to form a primary preform. The primary preform is either drawn into a hollow-core fiber or further processed into a secondary preform.

### CROSS-REFERENCE TO RELATED APPLICATIONS

This application claims priority pursuant to 35 U.S.C. 119 (a) to European Patent Application No. 24180449.1, filed Jun. 6, 2024, which application is incorporated herein by reference in its entirety.

### FIELD OF THE INVENTION

The invention relates to the field of optical fiber technology and, in particular, to the area of antiresonant hollow-core fibers (AR-HCF for short). The hollow-core region is surrounded by an inner cladding region in which so-called “antiresonance elements” (“ARE's” for short) are arranged. The walls, evenly distributed around the hollow core, of the ARE's can reflect the incident light and guide it through the fiber core. Hollow-core fibers therefore allow light to be guided within a “hollow” core that is either evacuated or filled with a gas (such as air).

This fiber technology promises low optical attenuation, a very broad transmission spectrum (even in the UV or IR wavelength ranges), and low latency period during data transmission. In addition, these fibers are suitable for spectroscopic applications as well as for the transmission of short laser pulses for high-power beam guidance, e.g., for material processing, modal filtering, nonlinear optics, in particular for supercontinuum generation, from the ultraviolet to the infrared wavelength range.

In particular, the invention relates to a method for fabricating a preform for an antiresonant hollow-core fiber which comprises a hollow core extending along a longitudinal axis of the fiber and an inner cladding region that surrounds the hollow core and comprises a plurality of antiresonance elements, comprising the method steps of:
(a) providing a cladding tube comprising a cladding tube inner bore with a cladding tube inside and a cladding tube center axis,
(b) providing a plurality of tubular antiresonance element preforms (ARE preforms for short), each comprising a primary tube and at least two secondary tubes, wherein each primary tube comprises a primary tube inner bore, a primary tube outer side, and a primary tube inner side,
(c) arranging the plurality of ARE preforms in the cladding tube inner bore to form a primary preform, wherein the primary tubes are uniformly distributed around the cladding tube inner side,
(d) thermally stretching the primary preform to form the hollow-core fiber or further processing the primary preform into a secondary preform from which the hollow-core fiber is drawn.

In addition, the invention also relates to a method for fabricating a preform for an antiresonant hollow-core fiber which comprises a hollow core extending along a longitudinal axis of the fiber and a cladding region that surrounds the hollow core and comprises a plurality of antiresonance elements, comprising the method steps of:
(a) providing a cladding tube comprising a cladding tube inner bore with a cladding tube inside and a cladding tube center axis,
(b) providing a plurality of tubular antiresonance element preforms (ARE preforms for short), each comprising a primary tube and at least two secondary tubes, wherein each primary tube comprises a primary tube inner bore, a primary tube outer side, and a primary tube inner side,
(c) arranging the plurality of ARE preforms in the cladding tube inner bore to form a primary preform, wherein the primary tubes are uniformly distributed around the cladding tube inner side,
(d) further processing the primary preform into a secondary preform.

Furthermore, the invention relates to a preform precursor for an antiresonant hollow-core fiber, wherein the preform precursor comprises: a cladding tube with a cladding tube inner bore, a cladding tube inside, and a cladding tube center axis; and a number of ARE preforms arranged on an inside of the cladding tube wall, each comprising a primary tube and at least two secondary tubes, wherein each primary tube comprises a primary tube inner bore, a primary tube outer side, and a primary tube inner side, and wherein the secondary tubes are arranged at a distance from each other at azimuthal contact points on the primary tube inside.

### BACKGROUND OF THE INVENTION

It is known to draw antiresonant hollow-core fibers from preforms that have a hollow core which is surrounded by a cladding in which at least some of the ARE's are arranged as a cross-sectional structure traversed by hollow channels. The preform is produced, for example, by collapsing and/or elongating a cylindrical preform precursor (for short: precursor), which in so doing can be covered with additional cladding material. The cylindrical precursor is, for example, an ensemble that consists of a cladding tube and a plurality of cylindrical starting components, or it is a solid hollow cylinder that comprises the hollow core and at least the cladding traversed by hollow channels, and which is also referred to below as a “core preform” (English: cane).

The starting components of the preform that form the cross-sectional structure traversed by hollow channels in the preform and the ARE's in the finished hollow-core fiber are hereafter also referred to as “antiresonance element preforms” (for short: “ARE preforms”). These are distributed around the inside of a cladding tube. In the simplest case, the ARE preforms are designed as tubes (or capillaries). Other ARE preforms are composed of a plurality of tubes nested with each other. For example, a preform for a hollow-core fiber with the so-called NANF design (nested antiresonant nodeless hollow core fibers) contains a plurality of ARE preforms, in the simplest case each consisting of an outer tube (hereafter also called “primary tube”) and a single nested element inner tube (hereafter also called “secondary tube”) that is arranged on the inside of the primary tube. In this simple NANF design, the contact point of the secondary tube on the inside of the primary tube is at the same azimuthal position (around the cladding surface) as the contact point between the primary tube and the cladding tube. The secondary tubes form additional hollow channels in the hollow-core fiber, which contribute to a reduction in the optical fiber attenuation in that they lead to multiple radial reflections and avoid transitions or nodes that lead to resonances.

However, simulations of the radial propagation profile of the optical power in the hollow-core fiber showed that, on the one hand, the majority of the optical power is lost through the center of the secondary tubes (leakage); and, on the other, that the gap between adjacent primary tubes acts as a barrier against power loss, with a gap reduction tending to further reduce the leakage.

A simulation-improved design of an antiresonant hollow-core fiber using these results is described in WO 2020/030888 A1. In contrast to the simple NANF design, the single secondary tube is replaced by a pair of secondary tubes that are spaced apart from each other and arranged on either side of the connecting line between the preform center axis and the contact point of the primary tube and cladding tube. A radially continuous and small gap is produced between each secondary tube pair in exactly the region that has the greatest leakage in the NANF design. This design is called “ALIF design” (antiresonant leakage inhibited fibers).

In the ALIF design, the secondary tube pairs spaced apart from each other are attached at azimuthal locations around the circumference of the primary tube; both are offset from the peripheral contact point of the primary tube on the cladding tube. This results in multiple radial reflections and avoids nodes that lead to resonances that would increase the leakage, reduce the bandwidth, and increase the optical losses.

The starting elements that form an ARE preform and therefore also each ARE preform exhibit a certain deviation from a target geometry. Each step of positioning and forming inevitably leads to further geometric deviations, which can add up to an absolute geometric error in the preform. This places great demands on accuracy when positioning and fixing the output elements in their respective target positions, in particular in the case of compact arrangements such as with the ALIF design.

To improve the positioning accuracy in a simple NANF design with a primary tube of quartz glass and a secondary tube of quartz glass arranged on its inner wall, WO 2022/128271 A1 proposes to elongate the ensemble consisting of the primary tube and secondary tube together into a capillary half-finished product. The elongated capillary half-finished product thus consists of an ARE outer capillary and an NE inner capillary firmly connected thereto. The elongated capillary half-finished products are mounted on the inner side of a jacket tube made of quartz glass. A template can be used for this mounting. The capillary half-finished products are fused to the inner side of the cladding tube, and this ensemble is elongated to form a preform precursor from which the hollow-core fiber is subsequently drawn.

WO 2019/008352 A1 discloses a method for fabricating preforms for antiresonant hollow-core fibers, in which primary tubes are positioned on the inner side of a cladding tube made of quartz glass and bonded there by means of a laser. A secondary tube can also be fastened to the inner side of the primary outer tube in advance using a laser, thus producing a prefabricated capillary half-finished product. The primary tube can be positioned, for example, by gravity or by means of magnetic elements.

In WO 2019/053412 A1, the primary tubes are positioned at predefined peripheral locations within the cladding tube using spacer elements, each of which is in contact with two adjacent primary tubes. The radial distance r2 between these contact points and the sheath tube middle axis is greater than the radial distance r1 between the longitudinal axes of the primary tube and the sheath tube middle axis. The spacer elements can form an integral structure of the jacket tube. The jacket tube inner side can be shaped by mechanical processing such that the spacer elements project radially inwards from the inner side. In one example, the spacer elements have a rectangular cross-section that projects from the concave inner side of the jacket tube.

Structuring the jacket tube inner wall to create spacer elements is time-consuming. When welding the ARE preforms to the spacer elements, sublimation of SiO₂ can lead to soot deposits, which have an adverse effect on the optical properties of the hollow-core fiber.

### Technical Problem

In order to comply with resonance or antiresonance conditions, even small dimensional deviations on the order of magnitude of the working wavelength of the light to be guided are not tolerable.

An aim of the invention is therefore to provide a method for fabricating an antiresonant hollow-core fiber with the ALIF design and a preform for such antiresonant hollow-core fibers, in which high precision of the antiresonance elements and exact positioning in the hollow-core fiber can be achieved reproducibly. In particular, the aim is to enable the ARE preforms to be positioned as precisely as possible at predetermined azimuthal positions of the cladding tube and to prevent or reduce soot deposits, in order to facilitate prediction of the drawing result.

Furthermore, the invention is based upon the object of specifying a preform precursor from which an antiresonant hollow-core fiber with antiresonance elements that are positioned as precisely and geometrically precisely as possible can be drawn in a reproducible manner.

### SUMMARY OF THE INVENTION

With regard to the method for producing the antiresonant hollow-core fiber, this object is achieved by a method having the features of claim 1.

In a known method for fabricating a preform for an antiresonant hollow-core fiber with an ALIF design, tubular antiresonance element preforms (ARE preforms for short), that each comprise a primary tube and at least two secondary tubes, are evenly distributed around the inside of a cladding tube to form a primary preform. The primary preform is either drawn into a hollow-core fiber or further processed into a secondary preform. In order to enable high precision of the ARE preforms and exact positioning at predetermined azimuthal positions of the cladding tube, it is proposed that the at least two secondary tubes be arranged at a distance from one another at azimuthal contact points on the inner side of the primary tube, and that the arrangement of primary tube and secondary tubes be thermally stretched to form a prefabricated ARE preform so that the prefabricated ARE preform has an oval cross-section with a long major axis (AL) and with a short major axis (AS), wherein the azimuthal contact points are located on both sides of the short major axis (AS), and wherein the prefabricated ARE preforms are evenly distributed at peripheral contact points on the inner side of the cladding tube and are arranged such that the short major axes (AS) each run radially to the central axis of the cladding tube.

Starting from a method for fabricating the hollow-core fiber according to the type mentioned above, the provision of the ARE preforms according to method step (b) comprises the following measures:
arranging the at least two secondary tubes at a distance from each other at azimuthal contact points on the inside of the primary tube,
thermally stretching the arrangement of primary tube and secondary tubes to form a prefabricated ARE preform which has an oval cross-section with a long major axis and a short major axis, wherein the azimuthal contact points are located on both sides of the short major axis, wherein, for arranging the plurality of ARE preforms according to method step (c), a plurality of the prefabricated ARE preforms are distributed uniformly at peripheral contact points of the cladding tube inside and arranged such that the short major axes each run radially to the cladding tube center axis.

The starting point for the production of the antiresonant hollow-core fiber is an ensemble of cylindrical starting components, which are also referred to here as the “primary preform.” The production of the primary preform usually comprises the installation of cylindrical ARE preforms and their connection to the inner side of the cladding tube. In the invention, at least a part of the ARE preforms is in the form of a prefabricated ARE preform. This is obtained by thermally stretching the arrangement of the primary tube and at least two secondary tubes. In the prefabricated ARE preform, the original primary tubes, and the original secondary tubes are therefore present in elongated form. It has the following properties:
(i) it consists of a (thermally stretched) primary tube and two or more (thermally stretched) secondary tubes, each of which is welded to the primary tube inside at an azimuthal contact point,
(ii) it represents a self-supporting structure that is composed of the primary tube and the secondary tubes, such that these tubes can be handled together in the form of the joined structure,
(iii) it has an oval cross-section, ideally an elliptical cross-section, with a long major axis and a short major axis,
(iv) the azimuthal contact points are located on different sides of the short major axis, and
(v) in the case of exactly two secondary tubes, the two azimuthal contact points in a preferred case are at the same distance from the short major axis; in an ideal case, they lie opposite each other mirror-symmetrically across the short major axis.

Several of the ARE preforms prefabricated in this way are evenly distributed on the inside of the cladding tube and arranged in such a way that the short major axes each run radially to the cladding tube central axis.

The oval prefabrication of the ARE preforms and their specific arrangement on the inside of the cladding tube contribute to achieving the technical object as follows:

Within a primary tube, there is only a limited space available for positioning the secondary tubes. It is best to keep the secondary tubes from contacting each other. Contact can occur in particular during elongation to fabricate the prefabricated ARE preform and during subsequent elongation processes of the primary preform, because the space that is available for the secondary tubes is further narrowed as a result of the collapsing and constriction processes that thereby occur.

The oval (ideally elliptical) cross-sectional shape of the prefabricated ARE preform is in particular evident in an oval (ideally elliptical) cross-sectional shape of the primary tube. Its oval inner cross-section has a comparatively long major axis. If the azimuthal contact points of two secondary tubes are located at the ends of the long major axis, these secondary tubes are at the maximum possible distance from each other, so that contact is avoided as best as possible. But even distances below this optimum can reduce the risk of contact compared to a round cross-sectional shape.

The prefabricated ARE preform is a self-supporting structure, and all components forming the structure can be handled together and, in particular, can be mounted together on the inside of the cladding tube. Positioning and alignment measures that would otherwise be required during individual mounting to fabricate the primary preform are therefore unnecessary.

Positioning and fastening of the individual components is easier to accomplish outside the cladding tube inner bore than inside the inner bore. In this respect, these mounting steps are simplified, and the dimensional accuracy of the ARE preforms is improved.

The prefabricated ARE preforms are inserted into the cladding tube inner bore only in method step (c). Prior to this, quality control is preferably carried out in which, for example, the dimensional accuracy of the prefabricated ARE preforms and the positions and mutual alignments of the individual components are checked.

During mounting, the prefabricated ARE preform is oriented on the inside of the cladding tube, so that the short major axis of the oval cross-section runs in the radial direction. With this orientation, the oval cross-section fits snugly against the curve of the inside of the cladding tube, which makes mounting easier and more precise. A special structural design of the cladding tube inner wall for the purpose of precise positioning of individual starting components of the ARE is not necessary for this. In the simplest case, the jacket tube inner bore has a round cross-section.

The primary preform fabricated using the produced ARE preforms can be drawn directly to form the hollow-core fiber. As a rule, however, the primary preform is further processed to fabricate the preform or a preform precursor referred to here as a “secondary preform.”

If necessary, the hollow-core fiber is drawn from the secondary preform. Cladding material is added, for example, by collapsing an overlay cylinder onto the primary preform or onto the secondary preform. The coaxial arrangement of primary preform and overlay cylinder is elongated when the overlay cylinder collapses or it is not being elongated.

The greater the degree of ovality, the longer the long major axis of the oval and the greater the maximum available free distance between the secondary tubes. In this regard, the prefabricated ARE preforms advantageously have a degree of ovality of at least 1.1. With a very high degree of ovality of more than 1.5, the space available for accommodating the secondary tubes can be reduced.

A small distance between the secondary tubes already in the prefabricated ARE preform can lead to contact between the secondary tubes during a subsequent elongation process of the primary preform, in which the primary tube partially collapses due to surface tension, which would render the primary preform unusable.

In this regard, it has proven advantageous if the secondary tubes in the prefabricated ARE preform are at a distance in the range of at least 500 μm from each other, preferably a distance in the range of 1 to 5 mm. Maintaining this distance is made easier by the oval cross-sectional shape of the prefabricated ARE preform.

A preferred procedure is characterized in that the primary tube has an inner diameter of at least 25 mm and a wall thickness of at least 1.5 mm.

The production of the prefabricated ARE preform includes a thermal stretching process in which the primary tube is drawn to the desired outer diameter and connected to the secondary tubes along its entire length. It has proven advantageous if the primary tube has an initial inner diameter of at least 25 mm and a wall thickness of at least 1.5 mm. For very large internal diameters of more than 100 mm and wall thicknesses of more than 10 mm, homogeneous heating of the primary tube can become increasingly difficult.

Due to the initially large radial dimensions of the starting components (primary tube and secondary tubes), the connection with the secondary tubes attains greater stability, which has a beneficial effect on the dimensional accuracy of the prefabricated ARE preform. In this regard, the secondary tubes preferably have an initial outer diameter of at least 12 mm and a wall thickness of at least 1.5 mm. For very large outer diameters of more than 70 mm and wall thicknesses of more than 6 mm, homogeneous heating of the secondary tubes can become increasingly difficult.

In this connection, an elongation ratio of at least 3.5 is advantageously set during thermal stretching of the arrangement of primary tube and secondary tubes to form the prefabricated ARE preform.

This is a comparatively large elongation ratio for thermal stretching of the starting components (primary tube and secondary tubes). This is also related to the initially large radial dimensions of the starting components, and it also contributes to a continuous, stable connection between the primary tube and the secondary tubes. At very large elongation ratios of more than 12, the stability of the thermal stretching process over time can become increasingly difficult to maintain.

It has proven advantageous if, in the cross-section of the prefabricated ARE preform, the long major axis and the short major axis intersect at a center point, and that straight lines through the center point and the azimuthal contact points of two of the secondary tubes form an angle of a maximum of 160 degrees, preferably an angle in the range of 70 to 160 degrees, and particularly preferably an angle in the range of 100 to 140 degrees.

The primary tube inner bore is divided by the long major axis more or less into a first sub-chamber and a second sub-chamber, wherein the at least two secondary tubes are basically located together in one of these two sub-chambers. This is advantageous for the light guidance in the hollow channel fiber, in which the secondary tubes are stretched to form “inner capillaries,” wherein, in addition to the wall thickness, the diameter and therefore the distance between the inner capillaries are also crucial.

With regard to the method for fabricating a preform for an antiresonant hollow-core fiber, the aforementioned object is achieved by a method according to claim 9.

Starting from a method for fabricating the preform according to the type mentioned above, the provision of the ARE preforms according to method step (b) comprises:
an arrangement of the at least two secondary tubes at a distance from each other at azimuthal contact points on the inside of the primary tube,
a thermal stretching the arrangement of primary tube and secondary tubes to form a prefabricated ARE preform which has an oval cross-section with a long major axis and a short major axis, wherein the azimuthal contact points are located on both sides of the short major axis and equidistant therefrom, wherein, for arranging the plurality of ARE preforms according to method step (c), a plurality of the prefabricated ARE preforms are distributed uniformly at peripheral contact points of the cladding tube inside and arranged such that the short major axes each run radially to the cladding tube center axis.

The starting point for the production of the antiresonant hollow-core fiber is an ensemble of cylindrical starting components which are also referred to here as the “primary preform.” The production of the primary preform usually comprises the installation of cylindrical ARE preforms and their connection to the inner side of the cladding tube. In the invention, at least a part of the ARE preforms is in the form of a prefabricated ARE preform that is obtained by thermally stretching the arrangement of primary tube and the at least two secondary tubes. In the prefabricated ARE preform, the original primary tubes and the original secondary tubes are therefore present in elongated form. It has the following properties:
(i) it consists of a (thermally stretched) primary tube and at least two (thermally stretched) secondary tubes, each of which is welded to the inside of the primary tube at an azimuthal contact point,
(ii) it represents a self-supporting structure composed of the primary tube and the secondary tubes, so that the primary tube and the secondary tubes can be handled together in the form of the joined structure,
(iii) it has an oval cross-section, ideally an elliptical cross-section, with a long major axis and a short major axis,
(iv) the azimuthal contact points are located on different sides of the short major axis, and
(v) in the case of exactly two secondary tubes, the two azimuthal contact points are preferably the same distance from the short major axis; in an ideal case, they are mirror-symmetrical about the short major axis.

To fabricate the ensemble, a plurality of the ARE preforms prefabricated in this way are evenly distributed on the inside of the cladding tube and arranged in such a way that the short major axes each run radially to the cladding tube central axis.

The oval prefabrication of the ARE preforms and their specific arrangement on the inside of the cladding tube contribute to achieving the technical object as follows:

Within a primary tube, there is only a limited space available for positioning the secondary tubes. It is best to keep the secondary tubes from contacting each other. Contact can occur in particular during thermal stretching to fabricate the prefabricated ARE preform and during subsequent elongation processes of the primary preform, because the space that is available for the secondary tubes is further narrowed as a result of the collapsing and constriction processes that thereby occur.

The oval (ideally elliptical) cross-sectional shape of the prefabricated ARE preform is in particular evident in an oval (ideally elliptical) cross-sectional shape of the primary tube. Its oval inner cross-section has a comparatively long major axis. If, in the case of exactly two secondary tubes, the azimuthal contact points are located at the ends of the long major axis, these secondary tubes are at the maximum possible distance from each other, such that contact is avoided as best as possible. But even distances below this optimum can reduce the risk of contact compared to a round cross-sectional shape.

The prefabricated ARE preform is a joined, self-supporting structure, and all components forming the structure can be handled together and, in particular, can be mounted together on the inside of the cladding tube. Positioning and alignment measures that would otherwise be required during individual mounting to fabricate the primary preform are therefore unnecessary. Positioning and fastening of the individual components is easier to accomplish outside the cladding tube inner bore than inside the inner bore. In this respect, these mounting steps are simplified, and the dimensional accuracy of the ARE preforms is improved.

The prefabricated ARE preforms are inserted into the cladding tube inner bore only in method step (c). Prior to this, quality control is preferably carried out in which, for example, the dimensional accuracy of the prefabricated ARE preforms and the positions and mutual alignments of the individual components are checked.

During mounting, the prefabricated ARE preform is oriented on the inside of the cladding tube, so that the short major axis of the oval cross-section runs in the radial direction. With this orientation, the oval cross-section fits snugly against the curve of the inside of the cladding tube, which makes mounting easier and more precise. A special structural design of the cladding tube inner wall for the purpose of precise positioning of individual starting components of the ARE is not necessary for this. In the simplest case, the jacket tube inner bore has a round cross-section.

Measures for fabricating the preform and in particular for fabricating the prefabricated ARE preforms are explained above in connection with the production of the hollow-core fiber, and these explanations are hereby incorporated.

With regard to the preform precursor for a hollow-core fiber, the aforementioned technical object is achieved by a preform precursor having the features of claim 10.

In particular, this object is achieved according to the invention, starting from a preform precursor of the type mentioned at the outset, in that at least some of the ARE preforms are present as prefabricated ARE preforms, each comprising an oval cross-section with a long major axis and with a short major axis, wherein the azimuthal contact points lie on both sides of the short major axis, and in that a plurality of the prefabricated ARE preforms are distributed uniformly at peripheral contact points of the cladding tube inside and arranged such that the short major axes each run radially to the cladding tube center axis.

The cladding region of the preform precursor comprises the cladding tube, which can be encased by further cladding material. On the inside of the cladding tube, ARE preforms are evenly distributed at peripheral contact points on the inside of the cladding tube and are connected thereto, for example, by gluing or thermal bonding. At least some of these ARE preforms, preferably all ARE preforms, are available as “prefabricated ARE preforms.” These each comprise a primary tube and at least two secondary tubes, which are fixed at azimuthal contact points on the inside of the primary tube inner bore.

The prefabricated ARE preforms are obtained by thermally stretching an arrangement that comprises an original primary tube and at least two original secondary tubes. The oval (ideally elliptical) cross-sectional shape of the prefabricated ARE preform is particularly evident in an oval (ideally elliptical) cross-sectional shape of the thermally stretched primary tube. The long major axis of the oval cross-section is larger than the diameter of a circle of the same area, such that a comparatively larger interior space is available along the long major axis. The oval cross-section therefore simplifies a contact-free arrangement of the secondary tubes within the primary tube inner bore. Prefabrication eliminates the need for positioning and alignment measures that would otherwise be required during mounting to fabricate the preform precursor. In this respect, these mounting steps are simplified, and the dimensional accuracy of the ARE preforms is improved.

The azimuthal contact points of the thermally stretched secondary tubes on the inside of the thermally stretched primary tube are located on both sides and, in the case of exactly two secondary tubes, preferably at the same distance from the short major axis.

The preform precursor corresponds to the “primary preform” described above. Measures for fabricating the primary preform are explained above, and these explanations are hereby incorporated with regard to the preform precursor.

### Definitions

Individual method steps and terms of the above description are further defined below. The definitions are part of the description of the invention. In the event of a substantive inconsistency between one of the following definitions and the rest of the description, the statements made elsewhere in the description take precedence.

For terms and measurement methods that are not specifically defined in the description, the interpretation according to the International Telecommunication Union (ITU) shall apply. Where no measurement method is specified for a parameter, the standard measurement method shall be used for that parameter and, in particular, the measurement method laid down in the relevant ISO standard whose publication date is closest to that of the present application. Should measurement conditions not have been specified, the standard conditions (SATP conditions) for the temperature will be 298.15 K (25° C., 77° F.) and for the absolute pressure 100 kPa (14.504 psi, 0.986 atm).

### Antiresonance Elements

Antiresonance elements can be simple or interleaved structural elements of the hollow-core fiber. They comprise at least two walls which, viewed from the direction of the hollow core, have a negative curvature (convex) or no curvature (flat, straight). They generally consist of a material that is transparent to the working light, e.g., glass, in particular doped or non-doped SiO₂, a plastic, in particular a polymer, a composite material, or a crystalline material.

### Preform

The preform is the component or component ensemble from which the antiresonant hollow-core fiber is drawn. The component or the component ensemble has the core-cladding cross-sectional structure of the hollow-core fiber.

### Preform Precursor—Ensemble—Core Preform

The preform is obtained by thermally stretching a preform precursor once or several times. The preform precursor (for short: precursor) is, for example, a more or less loose ensemble of cylindrical starting components (English: “stack” or “assembly”; here also referred to as “ensemble” or “primary precursor”), or it is a joined, solid hollow cylinder that comprises the hollow core and at least the cladding traversed by hollow channels (English: “cane”; here also referred to as “core precursor” or “secondary precursor”). In the ensemble, the cylindrical starting components and the cladding tube can be partially fused together, especially at the cladding tube ends. In the core preform, which can be obtained by collapsing and/or thermally stretching the ensemble, the starting components are usually connected to the cladding tube over the entire length.

Further processing the preform precursor results in either the preform or another preform precursor and can involve a single or repeated execution of one or more of the following hot forming processes:
(i) thermal stretching,
(ii) collapse,
(iii) collapse and simultaneous thermal stretching,
(iv) collapse of additional cladding material,
(v) collapse of additional cladding material and subsequent thermal stretching,
(vi) collapse of additional cladding material and simultaneous thermal stretching.

### Antiresonance Element Preform

Antiresonance element preforms are cylindrical starting components of a preform precursor product present in the form of an ensemble, which are arranged, for example, in a cladding tube inner bore. They are substantially transformed into hollow channels by thermal stretching in a later precursor or in the preform, and they ultimately form the antiresonance elements in the hollow-core fiber. Nested ARE preforms form nested antiresonance elements in the hollow-core fiber. They are composed of a primary tube and at least one additional structural element that is arranged in the inner bore of the primary tube. The at least one further structural element can be an additional tube that abuts the inner lateral surface of the primary tube. The further tube is referred to here as the “secondary tube.”

In the inner bore of the secondary inner tube, at least one further structural element can be arranged in the case of multiple nested ARE preforms—for example, a third tube abutting the inner lateral surface of the secondary tube, which is termed here the “tertiary tube.”

A prefabricated ARE preform is a self-supporting structure that contains a plurality of starting components, including a primary tube and at least one secondary tube that is connected to the inner side of the primary tube, such that the primary tube and secondary tube can be handled together in the form of the joined structure.

### Distance Between the Secondary Tubes

The secondary tubes are spaced apart from each other. For a prefabricated ARE preform with exactly two secondary tubes, the distance is the shortest free distance between the two secondary tubes. For a prefabricated ARE preform with more than two secondary tubes and with different distances between them, the distance is the shortest free distance measured in a straight line between the two secondary tubes that are arranged closest to each other (each seen in cross-section).

### Long Major Axis/Short Major Axis/Degree of Ovality

The longest cross-sectional axis is termed the “long major axis,” and the shortest cross-sectional axis of the oval cross-section of the prefabricated ARE preform is termed the “short major axis.” In the case of an elliptical cross-section, the long major axis corresponds to the large half-axis, and the short major axis corresponds to the small half-axis.

The “degree of ovality” refers to the axial length ratio of the longest cross-sectional axis and the shortest cross-sectional axis.

### Thermal Stretching/Collapsing/Elongation Ratio

The arrangement of primary tube and secondary tubes or the ensemble is thermally stretched (elongated). The stretching can take place without simultaneous collapse. Thermal stretching can be true-to-scale so that, for example, the shape and arrangement of starting components of the ensemble are reflected in the stretched, elongated end product. During thermal stretching, the ensemble or the arrangement of primary tube and secondary tubes can also not be drawn to scale, and their geometry can be changed.

In the collapse process, an inner bore is narrowed or annular gaps between the tubular component are closed or narrowed. Collapse can be combined with thermal stretching.

The elongation ratio is calculated in this regard as the ratio of the component diameters before and after thermal stretching.

### Cross-Section/Inner Bore

The term “cross-section” in connection with elongated ARE preforms, their cylindrical structural elements, and the ensemble always denotes the cross-section perpendicular to the respective longitudinal axis and, unless stated otherwise, in the case of tubular components, the cross-section of the outer contour (not the cross-section of the inner contour).

The designation “tube inner face” is also used as a synonym for “tube inner lateral surface,” and the designation “tube outer face” is also used as a synonym for “tube outer lateral surface.” The term “inner bore” in conjunction with a tube does not indicate that the inner bore has been produced by a drilling process.

### EXEMPLARY EMBODIMENT

The invention is explained in more detail below with reference to an exemplary embodiment and a drawing. In detail, in a schematic representation,

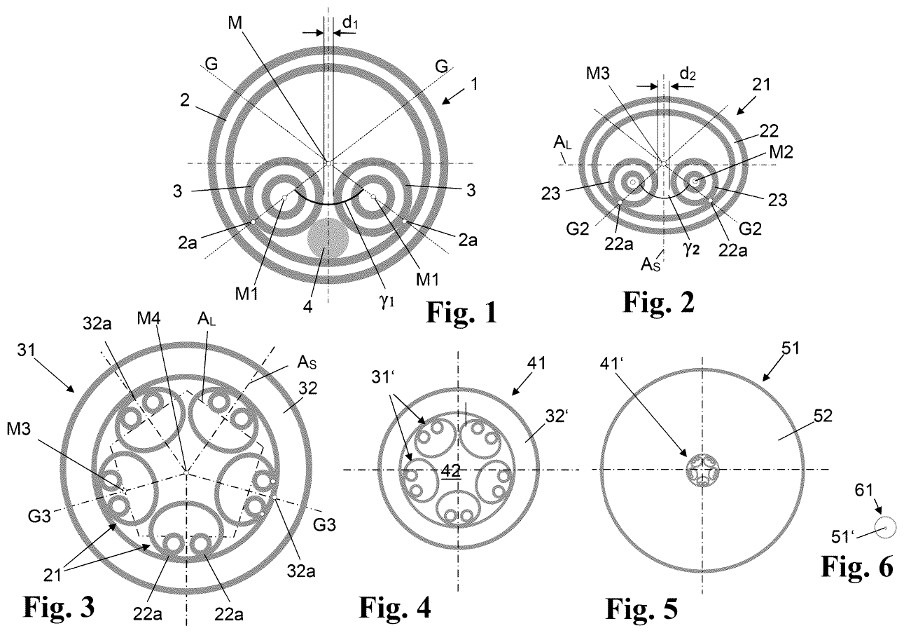

FIG. 1 shows a loose component ensemble consisting of a primary tube, two secondary tubes, and a spacer in a view of the tube end faces;

FIG. 2 shows a cross-section of a prefabricated ARE preform obtained from the component ensemble of FIG. 1 by thermal stretching;

FIG. 3 shows a cross-section of a primary preform with a cladding tube and five prefabricated ARE preforms arranged on the inside of the cladding tube;

FIG. 4 shows a cross-section of a first secondary preform produced by further processing the primary preform of FIG. 3;

FIG. 5 shows a cross-section of a second secondary preform produced by further processing the first secondary preform of FIG. 4; and,

FIG. 6 shows a cross-section of a hollow-core fiber with an ALIF design produced by further processing the second secondary preform of FIG. 5.

FIG. 1 shows in cross-section a loose assembly 1 consisting of a primary tube 2, two secondary tubes 3 arranged in the primary tube inner bore 2a, and rod-shaped, short spacers 4 on which the ends of the secondary tubes 3 rest. The tubes (2, 3) consist of undoped quartz glass and have a circular inner and outer cross-section. The central axes M of the primary tube 1 and the two central axes M2 of the secondary tubes 3 run parallel to each other. In cross-section, the two secondary tubes 3 each lie at an azimuthal contact point 2a on the inner side of the primary tube. The azimuthal contact points 2a each lie on straight lines G, which pass through the primary tube center point M and the respective secondary tube center points M1. The straight lines G form an angle g1 with each other. The two elongated secondary tubes 3 are at a free distance d1 from each other. In order to exclude any risk of contact between the secondary tubes 3 during the thermal stretching process, the free distance d1 is preferably at least 1 mm. And the angle g1 is preferably, for example, in the range of 70 to 160 degrees inclusive, particularly preferably in the range of 100 to 140 degrees.

The ends of the two secondary tubes 3 are locally thermally bonded to the inside of the primary tube 2 and are also welded to the spacers 4. Thereafter, the fixed assembly 1 is thermally stretched, wherein a predetermined elongation ratio is set.

The result of the stretching process is a prefabricated ARE preform 21 with an oval cross-section, as shown in the sketch of FIG. 2 using an example. The former primary tube 2 now forms an oval, elongated primary tube 22. The two former secondary tubes 3 form elongated secondary tubes 23, which are fused over their entire length with the inside of the elongated primary tube 22. In the shown cross-section, the fusions can be seen as azimuthal contact points 22a.

The elongated secondary tubes 23 continue to have a substantially circular cross-section with the center point M2. However, the elongated primary tube 22 shows a pronounced ovality which is characterized by a long major axis AL and a short major axis A_{S} which intersect at the center point M3. The two elongated secondary tubes 23 are located at the same distance on either side of the short major axis A_{S}, and they are at a free distance d2 from each other. The straight lines G2, which pass through the center point M3 and through the azimuthal contact points 22a of the secondary tubes 23, form an angle g2 with one another. The distance d2 and the angle g2 depend upon the degree of ovality of the elongated primary tube 22. The larger this is, the greater the extension of the distance d2 compared to the distance d1, and the wider the angle g2 compared to the angle g1. The angle g2 is therefore, for example, in the range of 75 to 165 degrees, preferably in the range of 105 to 145 degrees. The angles g2 and angle g1 are mirror-symmetrical to the short major axis in the exemplary embodiment. This means that the two half-angles on either side of the axis are each equally large. However, this is not an obligatory symmetry condition.

During the thermal stretching of the fixed assembly 1, the peripheral wall thickness distribution changes due to the fusion of the elongated secondary tubes 3 with the inside of the primary tube 2, which leads to asymmetric heat input and therefore to asymmetric flow of the glass and ultimately to the ovality of the elongated primary tube 22.

The table lists dimensions and method parameters for exemplary embodiments of the invention and comparative examples.

TABLE 1

| Sample | 1 | 2 | 3 | 4 | 5 | 6 | 7 | 8 | 9 | 10 |
|---|---|---|---|---|---|---|---|---|---|---|
| Starting components - | | | | | | | | | | |
| ARE preform | | | | | | | | | | |
| Inner diameter of primary | 44.00 | 44.00 | 25.00 | 25.50 | 30.00 | 30.00 | 99.00 | 99.00 | 44.00 | 24.00 |
| tube [mm] | | | | | | | | | | |
| Wall thickness of primary | 4.00 | 2.00 | 4.00 | 10.00 | 3.50 | 3.50 | 3.50 | 4.00 | 2.00 | 2.00 |
| tube [mm] | | | | | | | | | | |
| Outer diameter of | 18.30 | 18.30 | 12.00 | 12.20 | 13.50 | 13.50 | 43.00 | 45.00 | 18.30 | 10.00 |
| secondary tube [mm] | | | | | | | | | | |
| Angle gamma 1 [degrees] | 105 | 100 | 160 | 140 | 160 | 120 | 120 | 120 | 100 | 120 |
| Distance d1 [mm] | 2.09 | 1.39 | 0.80 | 0.30 | 2.75 | 0.79 | 5.50 | 1.77 | 1.39 | 2.12 |
| Prefabricated | | | | | | | | | | |
| ARE preform | | | | | | | | | | |
| Elongation ratio | 3.60 | 8.00 | 5.00 | 5.00 | 5.00 | 5.00 | 5.00 | 5.00 | 14.00 | 5.00 |
| Degree of ovality | 1.24 | 1.39 | 1.28 | 1.14 | 1.29 | 1.29 | 1.29 | 1.28 | 1.54 | 1.32 |
| Long major axis of primary | 12.93 | 9.53 | 6.37 | 6.50 | 7.65 | 7.65 | 27.11 | 25.24 | 7.20 | 5.63 |
| tube, elongated [mm] | | | | | | | | | | |
| Short half-axis of primary | 10.39 | 6.35 | 4.90 | 5.00 | 5.88 | 5.88 | 18.07 | 19.42 | 4.80 | 5.12 |
| tube, elongated [mm] | | | | | | | | | | |
| Distance d2 [mm] | 1.23 | 0.60 | 0.41 | 0.15 | 1.40 | 0.40 | 3.01 | 0.90 | 0.45 | 1.00 |

Sample 1 of Table 1 is a typical exemplary embodiment of the invention. The azimuthal contact points 2a of the secondary tubes form an angle gamma 1 of 105 degrees. The distance d1 between the secondary tubes is 2.09 mm. After thermal stretching with an elongation ratio of 3.6, a prefabricated ARE preform is obtained in which the distance d2 between the elongated secondary tubes is 1.23 mm.

In comparison, with sample 2, in particular due to the larger elongation ratio and the smaller angle gamma 1 in the prefabricated ARE preforms, a distance d2 between the elongated secondary tubes of 0.6 mm is obtained, which can still be considered sufficiently large.

In samples 3 and 4, the primary tube has a comparatively small inner diameter which is almost completely filled by the secondary tubes (d1=0.8 mm; and d1=0.3 mm, respectively). In this configuration, after thermal stretching in the prefabricated ARE preform, a smaller distance d2 results between the elongated secondary tubes. The sample is therefore considered a comparative example.

The starting components of samples 5 and 6 have the same dimensions. The samples differ only in the arrangement of the secondary tubes (angle gamma 1). The larger angle gamma 1 of sample 5 results in a large distance d2 of 1.40 mm in the prefabricated ARE preform, whereas sample 6 results in a much smaller distance d2 of 0.40 mm.

In samples 7 and 8, the primary tubes have a comparatively large inner diameter, and the secondary tubes have a large outer diameter, such that they almost completely fill the inner bore of the primary tube. With sample 8, the resulting distance d1 is 1.77 mm which, after thermal stretching in the prefabricated ARE preform, results in a comparatively small but still sufficiently large distance d2 of 0.90.

With sample 9, a comparatively large elongation ratio of 14 leads to a high degree of ovality of 1.54 for the given dimensions of the starting components.

Sample 10 is a comparative example. The thermal stretching process could not be completed in this sample. This may be due to the fact that the radial dimensions of the original primary tube and the original secondary tubes were too small to provide sufficient mechanical stability.

The prefabricated oval ARE preforms 21 are used to fabricate an ensemble 31 (primary preform). Five prefabricated ARE preforms 21 are arranged in the inner bore of a cladding tube 32 with an outer diameter of 41 mm. As shown in the cross-sectional view of FIG. 3, the prefabricated ARE preforms 21 are evenly distributed at peripheral contact points 32a on the inside of the cladding tube 32 and are oriented in such a way that the short major axes A_{S} each run radially to the cladding tube center axis M4. A positioning template can be used for this purpose. The two azimuthal contact points 22a on the inside of each of the elongated primary tubes 22 are located on both sides and at the same distance from a straight line G3 which runs through the cladding tube central axis M4 and through the peripheral contact point 32a on the inside of the cladding tube 32. The straight line G3 runs simultaneously in the short major axis A_{S} of the elongated and oval-shaped primary tube 22.

In the region of their front ends, the ARE preforms 21 are melted on the inside of the cladding tube and elongated in a first thermal stretching process to form a first secondary preform (core preform 41) with an outer diameter of 23 mm. FIG. 4 shows a cross-section of the core preform 41 (cane) obtained by thermal stretching of the ensemble 31. During this hot forming process, the original prefabricated ARE preforms 21′ are bonded over their entire length to the inside of the former cladding tube 32′.

FIG. 5 shows a second secondary preform 51, which has been obtained by thermally stretching the first secondary preform (former core preform 41) with simultaneous overlaying with cladding material 52, and whose outer diameter is 28 mm. The former core preform is designated by reference number 41′. It comprises a hollow-core region 42 that is surrounded by an inner cladding region that is formed by the former ARE preforms 31′ and an outer cladding region that is formed by the former cladding tube 32′.

FIG. 6 schematically shows a hollow-core fiber 61 with an ALIF design with an outer diameter of 0.23 mm, which is produced by drawing the second secondary preform 51. During the fiber drawing process, there is also a further reduction in the free distance between the elongated secondary tubes. However, contact is prevented, which can be attributed to the initial ovality of the prefabricated ARE preforms 21 and in particular to the ovality of the elongated primary tubes 22.

1. A method for fabricating an antiresonant hollow-core fiber preform, the hollow-core fiber having a hollow core extending along a fiber longitudinal axis and an inner cladding region surrounding the hollow core, the inner cladding region comprising a plurality of antiresonance elements, the method comprising the steps of:
(a) providing a cladding tube having a cladding tube inner bore with a cladding tube inside and a cladding tube center axis,
(b) providing a plurality of tubular antiresonant element preforms (ARE), each comprising a primary tube and at least two secondary tubes, each primary tube having a primary tube inner bore, a primary tube outer side and a primary tube inner side,
(c) arranging the plurality of ARE preforms in the cladding tube inner bore to form a primary preform, wherein the primary tubes are uniformly distributed around the cladding tube inner side,
(d) thermally stretching the primary preform to form the hollow core fiber or further processing the primary preform to a secondary preform from which the hollow core fiber is drawn,
wherein providing the ARE preforms according to process step (b) comprises in each case:
arranging the at least two secondary tubes at a distance from each other at azimuthal contact points (2a) on the inside of the primary tube,
thermally stretching the arrangement of primary tube and secondary tubes to form a prefabricated ARE preform (21) which has an oval cross section with a long major axis (AL) and a short major axis (AS), wherein the azimuthal contact points (22a) are located on both sides of the short major axis (AS),
wherein, for arranging the plurality of ARE preforms according to process step (c), a plurality of the prefabricated ARE preforms are distributed uniformly at peripheral contact points (32a) of the cladding tube inside and arranged such that the short main axes (AS) each run radially to the cladding tube center axis (M4).

2. The method according to claim 1, wherein the prefabricated ARE preforms have a degree of ovality of at least 1.1.

3. The method according to claim 1, wherein the secondary tubes in the preassembled ARE preform have a distance (d2) in the range of at least 500 μm from one another, preferably a distance (d2) in the range of 1 to 5 mm, particularly preferably less than 3 mm.

4. The method according to claim 1, wherein the primary tube has an initial inner diameter of at least 25 mm and a wall thickness of at least 1.5 mm.

5. The method according to claim 1, wherein the secondary tubes have an initial external diameter of at least 12 mm and a wall thickness of at least 1.5 mm.

6. The method according claim 1, wherein an elongation ratio of at least 3.5 is set during the thermal stretching of the arrangement of primary tube and secondary tubes to form the preassembled ARE preform.

7. The method according to claim 1, wherein the cross section of the preassembled ARE preform the long major axis and the short major axis intersect at a midpoint, and in that straight lines through the midpoint and the azimuthal contact points of two of the secondary tubes enclose an angle of at most 160 degrees, preferably an angle in the range from 70 to 160 degrees and particularly preferably an angle from 100 to 140 degrees.

8. The method according to claim 1, wherein two azimuthal contact points (22a) are located on either side of the short major axis (AS) and are at an equal distance therefrom.

9. A method of making a preform for an antiresonant hollow-core fiber, the fiber having a hollow core extending along a fiber longitudinal axis and an inner cladding region surrounding the hollow core, the inner cladding region comprising a plurality of antiresonance elements, the method comprising the steps of:
(a) providing a cladding tube having a cladding tube inner bore with a cladding tube inside and a cladding tube center axis,
(b) providing a plurality of tubular ARE preforms, each comprising a primary tube and at least two secondary tubes, each primary tube having a primary tube inner bore, a primary tube exterior, and a primary tube interior;
(c) arranging the plurality of ARE preforms in the cladding tube inner bore to form a primary preform, the primary tubes being uniformly distributed around the cladding tube inner side,
(d) further processing the primary preform into a secondary preform,
characterized in that providing the ARE preforms according to method step (b) comprises in each case:
arranging the at least two secondary tubes at a distance from each other at azimuthal points of contact on the inside of the primary tube,
thermally stretching the arrangement of primary tube and secondary tubes to form a prefabricated ARE preform having an oval cross section with a long major axis and a short major axis, wherein the azimuthal contact points are located on both sides of the short major axis and are at the same distance from it,
wherein, for arranging the plurality of ARE preforms according to process step (c), a plurality of the prefabricated ARE preforms are uniformly distributed at peripheral contact points of the cladding tube inside and arranged such that the short main axes each extend radially to the cladding tube center axis.

10. An antiresonant hollow-core fiber preform precursor, the preform precursor comprising: a cladding tube having a cladding tube inner bore, a cladding tube inside, and a cladding tube center axis; and a number of ARE preforms arranged on an inside of the cladding tube's tube wall, each having a primary tube and at least two secondary tubes, each primary tube having a primary tube inner bore, a primary tube outer side and a primary tube inner side, and the at least two secondary tubes are arranged at a distance from each other at azimuthal contact points on the primary tube inside, characterized in that at least some of the ARE preforms are present as prefabricated ARE preforms, which each have an oval cross section with a long main axis and with a short main axis, with the azimuthal contact points lying on both sides of the short main axis, and in that a plurality of the preassembled ARE preforms are uniformly distributed at peripheral contact points of the cladding tube inside and are arranged such that the short main axes each run radially to the cladding tube center axis.

11. The preform precursor according to claim 10, wherein the preassembled ARE preforms have a degree of ovality of at least 1.1.

12. The preform precursor according to claim 10, wherein the secondary tubes in the preassembled ARE preform are at a distance of at least 500 μm from one another, preferably at a distance in the range from 1 to 5 mm.

13. The preform precursor according to claim 10, wherein the cross section of the prefabricated ARE preforms the long main axis and the short main axis intersect at a midpoint and that straight lines through the center point and the azimuthal contact points of two of the secondary tubes enclose an angle of less than 165 degrees, preferably an angle in the range of 75 to 165 degrees.

14. The preform precursor according to claim 10, wherein two azimuthal contact points (22a) are located on either side of the short main axis (AS) and are at an equal distance therefrom.
